(19) United States
(12) Patent Application Publication
(10) Pub. No.: US 2024/0049707 A1
(43) Pub. Date: Feb. 15, 2024

(54) PESTICIDE COMPOSITIONS OF LICOCHALCONE C

(71) Applicant: METABOLIC INSIGHTS LTD., Ness-Ziona (IL)

(72) Inventors: David PANIK, Rehovot (IL); Ido KORMAN, Sde Nitzan (IL)

(21) Appl. No.: 18/267,632

(22) PCT Filed: Nov. 3, 2021
(86) PCT No.: PCT/IL2021/051303

§ 371 Date: Jun. 15, 2023

(30) Foreign Application Priority Data
Dec. 21, 2020 (IT) 102020000031712

(51) Int. Cl. A01N 31/16; A01P 1/00; A01P 3/00

(52) U.S. Cl. CPC A01N 31/16; A01P 1/00; A01P 3/00

(57) ABSTRACT

A composition comprising Licochalcone C or an agriculturally acceptable salt thereof as an active pesticidal ingredient is provided. A method for controlling, preventing, reducing or eradicating the instances of plant-pathogen infestation on a plant, plant organ, plant part, or plant propagation material is further provided, the method comprising: applying to a plant, plant part, plant organ or plant propagation material, or to soil surrounding said plant, a pesticidal effective amount of Licochalcone C or a pesticide composition comprising it, wherein said plant-pathogen is a member selected from: an order of the class Agaricomycetes; a genus of the family Pythiaceae, a genus of the family Sclerotiniaceae selected from Sclerotinia and Fusarium, and family of the order Pseudomonadales.

### FIELD OF THE INVENTION

The present invention relates in general to a compound having fungicidal and bactericidal properties for agricultural uses.

### BACKGROUND OF THE INVENTION

Plant pests and diseases represent major challenges to productivity in modern agriculture. Soil-borne plant pathogens cause crucial damage to agricultural crops. The phytopathogenic fungus Rhizoctonia spp. belongs to phylogenetic lineage of Basidiomycetes. It causes a wide range of commercially significant plant diseases, such as brown patch, damping off in seedlings, root rot and belly rot in vegetable crops and sheath blight in rice. All Rhizoctonia diseases, and subsequent secondary infections in plants are difficult to control (Erlacher et al., 2014).

Pythium spp. is phytopathogenic fungus-like organism which belongs to phylogenetic lineage of eukaryotic microorganisms called Oomycetes which causes the widespread “damping off” disease of tobacco, tomato, mustard, chilies and cress seedlings (Martin & Loper, 2010).

Fusarium spp. is a large genus of filamentous fungi belonging to phylogenetic lineage of Ascomycetes. Many species of Fusarium are pathogenic to plants and cause serious diseases like wilt or ‘rot’ of economically important plants, mostly vegetables. In addition, Fusarium species infects cereals causing head blight and ear rot in maize and cause to mycotoxins accumulation under certain conditions (J. E. E. Jenkins, Y. S. Clark and A. E. Buckle, 1998).

Sclerotinia spp. is a plant pathogenic fungus belonging to phylogenetic lineage of Ascomycetes. Sclerotinia spp. causes to disease called white mold in many plant hosts, most of them vegetables (https://anrcatalog.ucanr.edu/pdf/8042.pdf).

Pseudomonas spp. is a plant pathogenic bacterial genus which is virulent in the diverse arrays of crop plants and causes to significant leaf and stem lesions. Pseudomonas spp. causes the following diseases in economically significant crops plants and orchards such as: pith necrosis in parsnip and tomato, brown blotch and leaf sheath brown rot in rice, bacterial canker in almonds and olive knot disease in olives (Moore L. W., 1988; Hofte M. and De Vos P., 2006). A variety of methods have been tested for the management of Pseudomonas spp. in crop plants. They include cultural management, host resistance, biological control with microbial antagonists and chemical control. None of them gives full control.

The number of available active ingredients for crop protection purposes against these diseases is diminishing from year to year due to increasing pest resistance, erratic climatic conditions and mounting regulatory pressure. New active ingredients are urgently needed for development of novel environmentally sustainable crop protection solutions.

### SUMMARY OF INVENTION

In one aspect, the present invention is directed to a pesticide composition comprising Licochalcone C or an agriculturally acceptable salt thereof as an active pesticidal ingredient.

In another aspect, the present invention provides a method for controlling, preventing, reducing or eradicating plant-pathogen infestation or instances thereof, on a plant, plant organ, plant part, or plant propagation material, the method comprising: applying to a plant, plant organ or plant propagation material, or to the soil surrounding said plant, a pesticidal effective amount of Licochalcone C or the pesticide formulation of any one of the below mentioned embodiments, wherein said plant-pathogen is a member selected from: an order of the class Agaricomycetes; a genus of the family Pythiaceae, a genus of the family Sclerotiniaceae selected from Sclerotinia and Fusarium, and family of the order Pseudomonadales.

### BRIEF DESCRIPTION OF DRAWINGS

FIGS. 1-8 show the effect of Licochalcone C (LIC) on cucumber seedlings survival in 8 independent experiments determined as percentage of disease severity 7 days following inoculation with Pythium aphanidermatum. FIGS. 9-11 show effect of Licochalcone C (LIC) on cucumber seedlings survival in 3 independent experiments determined as of disease severity 7 days following inoculation with Rhizoctonia solani. * means that p-value <0.05, ** means that p-value is <0.01, # means that p-value <0.1, n.s. means non-significant difference vs. non-treated plants. For formulation description used for Licochalcone C see Example 7. In summary, Licochalcone C showed excellent efficacy (up to 100%) in preventing plant mortality caused by Pythium and Rhizoctonia.

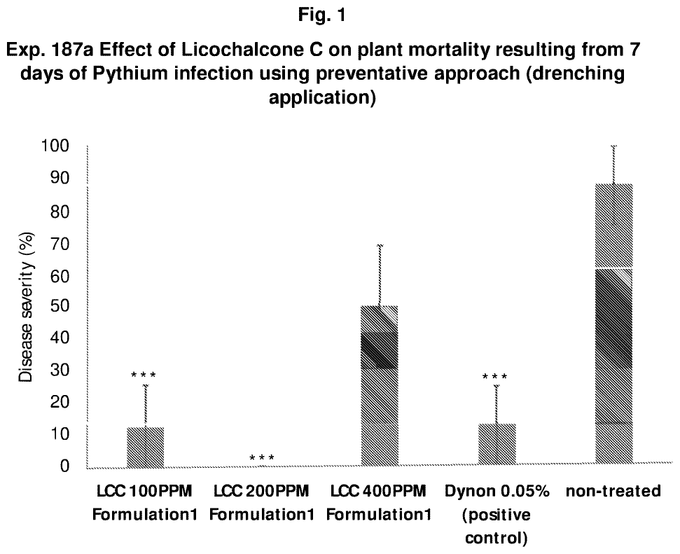

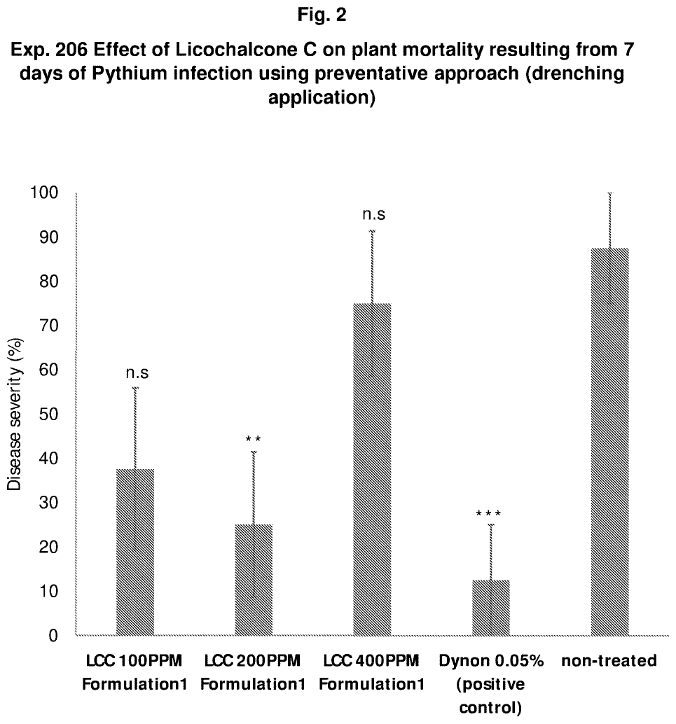

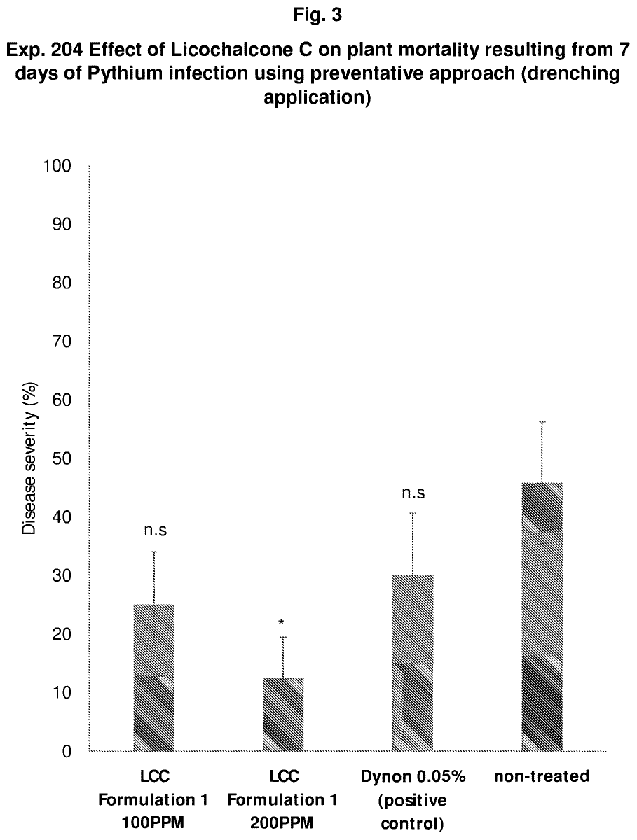

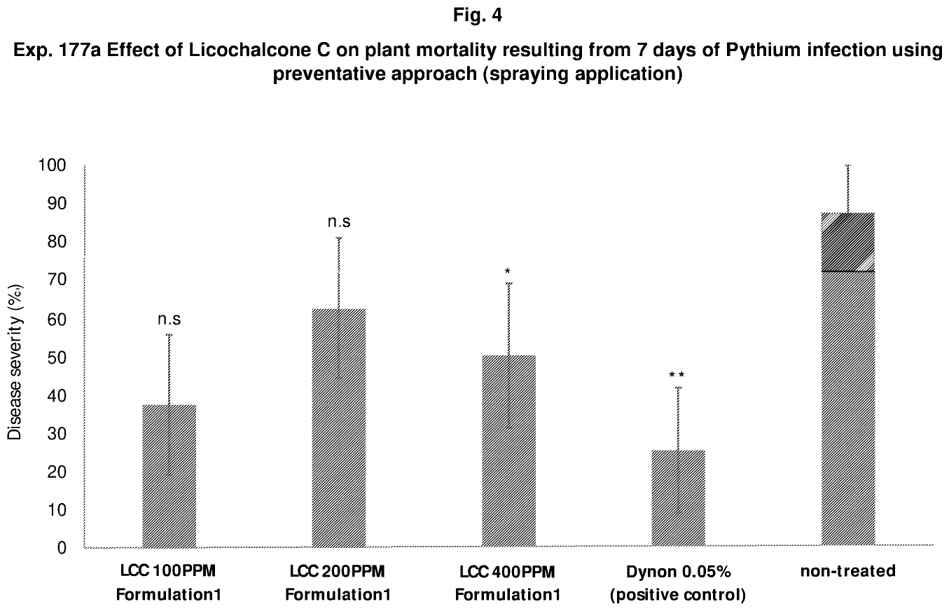

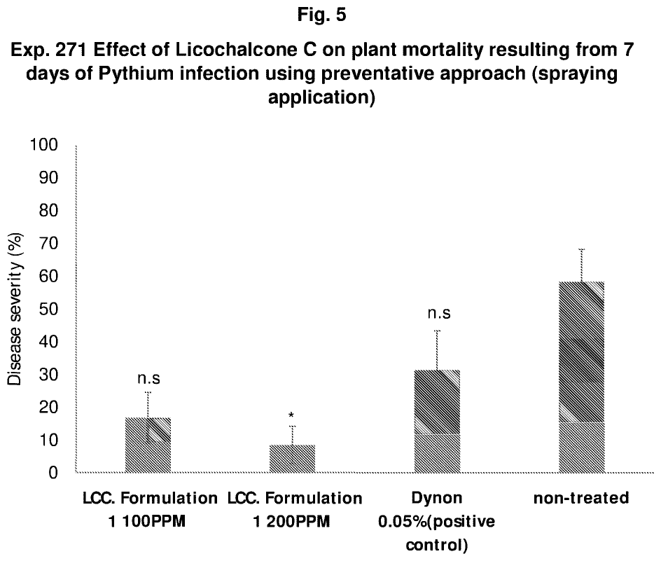

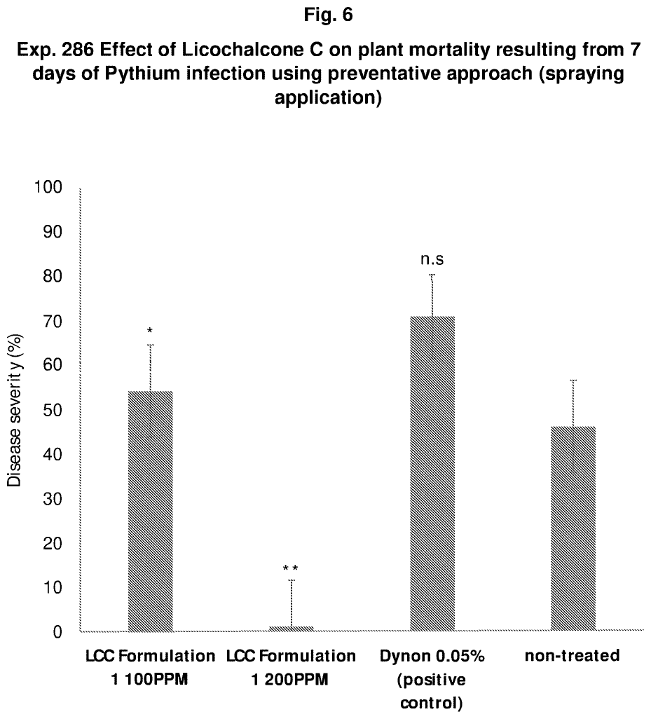

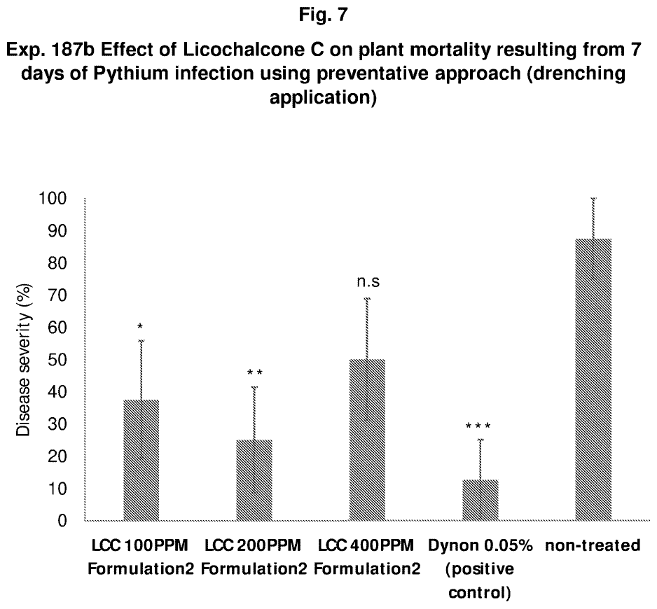

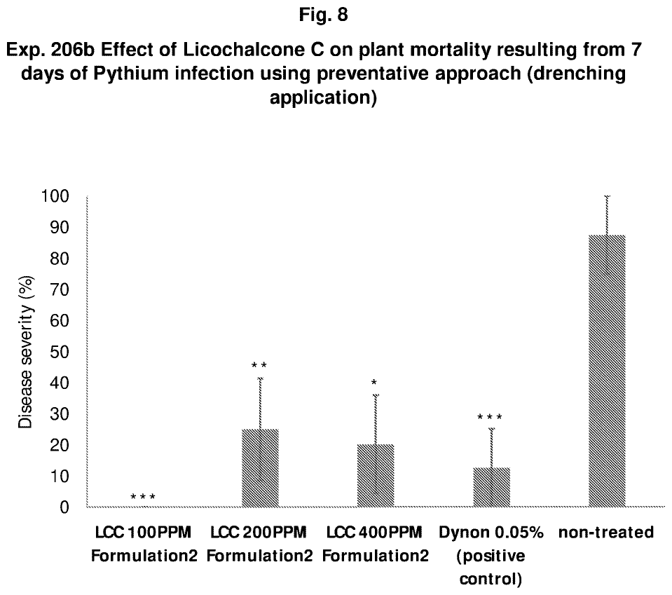

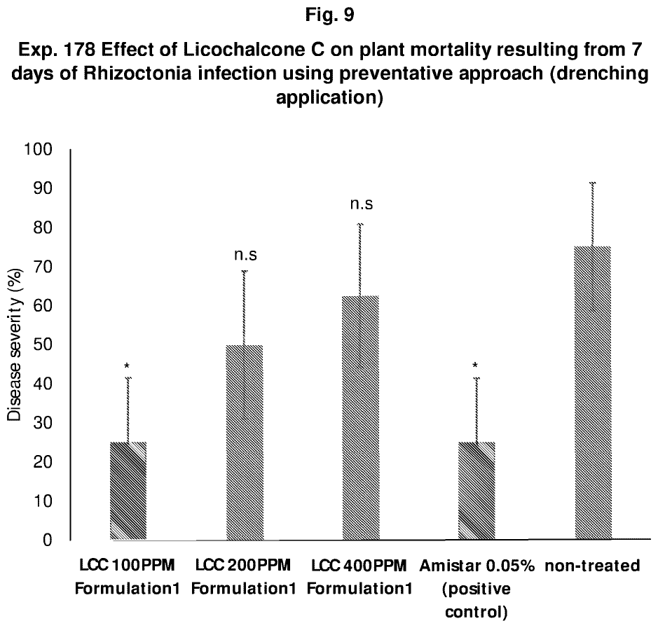

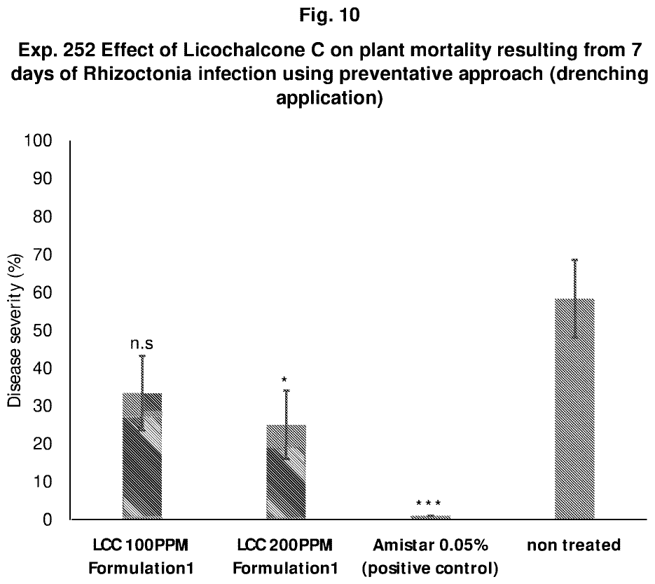

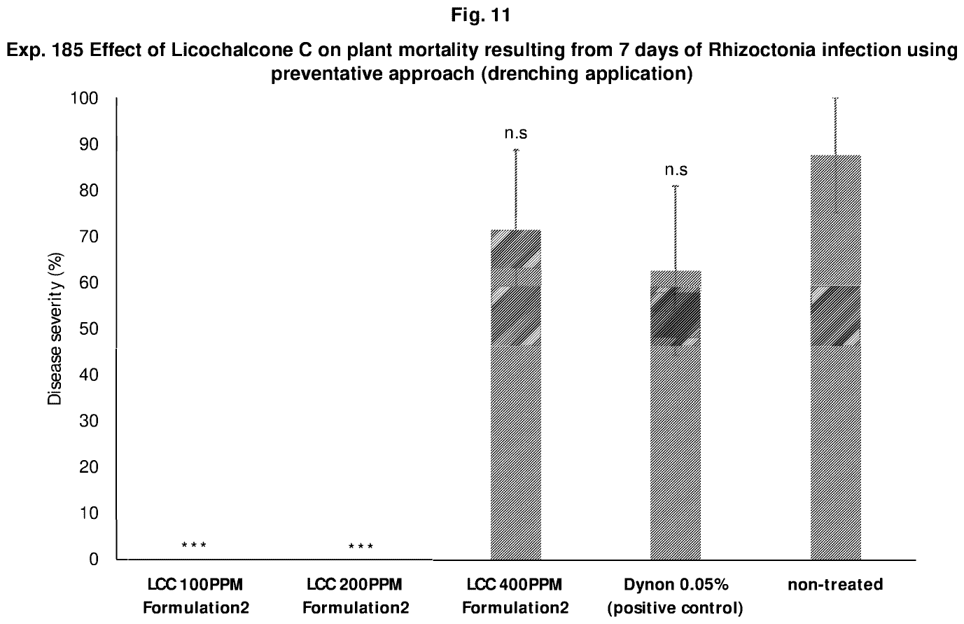

### DETAILED DESCRIPTION OF THE INVENTION

It has been found in accordance with the present invention that Licochalcone C is a potent pesticide against Rhizoctonia solani, a member of the class Agaricomycetes; Pythium aphanidermatum, a member of the family Pythiaceae; Sclerotinia sclerotiorum and Fusarium oxysporum, members of the family Sclerotiniaceae; and Pseudomonas syringae, a member of the order Pseudomonadales.

The CAS registry identifies Licochalcone C as (E)-3-[4-hydroxy-2-methoxy-3-(3-methylbut-2-enyl)phenyl]-1-(4-hydroxyphenyl)prop-2-en-1-one of the following formula:

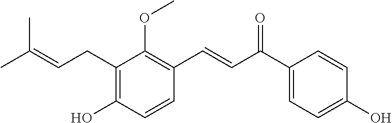 [SMILES: COc1c(/C=C/C(=O)c2ccc(O)cc2)ccc(O)c1CC=C(C)C]

The CAS registry number is 144506-14-9. Licochalcone C is a member of the class of retrochalcones.

In certain embodiments, the pesticide composition further comprises an agriculturally suitable or acceptable solvent or solubilising agent.

In certain embodiments, the agriculturally acceptable solvent or solubilising agent is a water-miscible solvent capable of dissolving or solubilising Licochalcone C.

In certain embodiments, the water-miscible solvent capable of dissolving or solubilising Licochalcone C is a polar solvent, such as an alcohol, a ketone, a lactone, a keto-alcohol, a glycol, a glycoether, an amide, an alkanolamine, a sulfoxide and a pyrolidone.

In particular embodiments, the composition comprises a solvent selected from dimethyl-sulfoxide or ethanol, and a polysorbate-type nonionic surfactant that is polysorbate 20.

In another aspect, the present invention provides a method for controlling, preventing, reducing or eradicating plant-pathogen infestation or instances thereof, on a plant, plant organ, plant part, or plant propagation material, the method comprising: applying to a plant, plant organ or plant propagation material, or to soil surrounding said plant, a pesticidally effective amount of Licochalcone C or pesticidally active salts thereof as an active pesticidal ingredient, or the pesticide composition of any one of the above embodiments, wherein said plant-pathogen is a member selected from: an order of the class Agaricomycetes; a genus of the family Pythiaceae, a genus of the family Sclerotiniaceae selected from Sclerotinia and Fusarium, and a family of the order Pseudomonadales.

The method of treatment of the present invention is useful for example against the following diseases: Rhizoctonia spp. causing brown patch, damping off in seedlings, root rot and belly rot in vegetables and sheath blight in rice; “damping off” disease caused by Pythium spp. in tobacco, tomato, cucumbers, mustard, chilies and cress seedlings; Fusarium spp. causing wilt or ‘rot’ of vegetables, bananas; Fusarium spp. head and ear rot in maize; Fusarium graminearum head blight in small grains; white mold caused by Sclerotinia spp. in many plants, mostly vegetables; Pseudomonas spp. pith necrosis in parsnip and tomato, brown blotch and leaf sheath brown rot in rice, bacterial canker in almonds and olive knot disease in olives.

In certain embodiments, the plant-pathogen is a member of the class Agaricomycetes.

In certain embodiments, the Agaricomycetes plant-pathogen is a member of the order Cantharellales.

In certain embodiments, the Cantharellales plant-pathogen is a member of the family Ceratobasidiaceae.

In certain embodiments, the Ceratobasidiaceae plant-pathogen is a member of the genus Rhizoctonia, such as Rhizoctonia solani, Rhizoctonia bataticola also known as Macrophomina phaseolina, Rhizoctonia carotae also known as Fibulorhizoctonia carotae, Rhizoctonia cerealis-asexual form of Ceratobasidium cereale, Rhizoctonia crocorum also known as Thanatophytum crocorum (asexual form of Helicobasidium purpureum), Rhizoctonia fragariae which is asexual form of Ceratobasidium cornigerum, Rhizoctonia goodyerae-repentis also known as Ceratobasidium cornigerum, Rhizoctonia oryzae also known as Waitea circinate, and Rhizoctonia ramicola also known as Ceratorhiza ramicola (asexual form of Ceratobasidium ramicola).

In certain embodiments, the plant-pathogen is Rhizoctonia solani.

In certain embodiments, the plant-pathogen is a member of the family Pythiaceae.

In certain embodiments, the Pythiaceae plant-pathogen is a member of the genus Pythium, such as Pythium aphanidermatum and Pythium ultimum.

In certain embodiments, the plant-pathogen is the species Pythium aphanidermatum.

In certain embodiments, the plant-pathogen is a member of Sclerotiniaceae selected from Sclerotinia and Fusarium.

In certain embodiments, the plant-pathogen is a member of the genus Fusarium, such as Fusarium oxysporum, Fusarium avenaceum, Fusarium bubigeum, Fusarium circinatum, Fusarium crookwellense, Fusarium culmorum, Fusarium graminearum, Fusarium langsethiae, Fusarium poae, Fusarium proliferatum, Fusarium solani, Fusarium sporotrichioides, Fusarium tricinctum, Fusarium venenatum, Fusarium verticillioides, and Fusarium virguliforme.

In certain embodiments, the plant-pathogen is Fusarium oxysporum.

In certain embodiments, the plant-pathogen is a member of the genus Sclerotinia such as Sclerotinia sclerotiorum, Sclerotinia borealis, Sclerotinia bulborum (Wakker) Sacc., Sclerotinia homoeocarpa F. T. Benn., Sclerotinia minor Jagger, Sclerotinia ricini, Sclerotinia sclerotiorum (Lib.) de Bary, Sclerotinia spermophila Noble, Sclerotinia sulcate, Sclerotinia trifoliorum Erikss., and Sclerotinia veratri.

In certain embodiments, the plant-pathogen is Sclerotinia sclerotiorum.

In certain embodiments, the plant-pathogen is a member of the order Pseudomonadales.

In certain embodiments, the Pseudomonadales plant-pathogen is a member of the family Pseudomonadaceae.

In certain embodiments, the Pseudomonadaceae plant-pathogen is a member of the genus Pseudomonas, such as Pseudomonas aeroginosa and Pseudomonas syringae.

The pesticide composition of the present invention may be formulated into a formulation to facilitate application of the active pesticidal ingredient.

The formulation may be a water-miscible formulation, such as a suspension concentrate (SC), a capsule suspension (CS), water-dispersible granules (WG), an emulsifiable concentrate (EC), a wettable powder (WP), a soluble (liquid) concentrate (SL), and a soluble powder (SP).

This formulation may further comprise at least one solvent or solubilising agent, adjuvant, carrier, diluent, and/or surfactant.

Non-limiting examples of adjuvants are activator adjuvants, such as cationic, anionic or non-ionic surfactants, oils and nitrogen-based fertilisers capable of improving activity of the pesticide product. Oils may be crop oils, such as paraffin or naphtha-based petroleum oil, crop oil concentrates based on emulsifiable petroleum-based oil, and vegetable oil concentrates derived from seed oil, usually cotton, linseed, soybean, or sunflower oil, used to control grassy weeds. Nitrogen-based fertilisers may be ammonium sulphate or urea-ammonium nitrate.

Non-limiting examples of solubilising agents or solvents are petroleum-based solvents, the aforementioned oils, liquid mixtures of fatty acids, ethanol, glycerol and dimethyl sulfoxide. The agriculturally acceptable solvent or solubilising agent may be a water-miscible solvent capable of dissolving or solubilising Licochalcone C, such as a polar solvent, e.g., an alcohol, a ketone, a lactone, a keto-alcohol, a glycol, a glycoether, an amide, an alkanolamine, a sulfoxide and a pyrrolidone.

Non-limiting examples of carriers are precipitated silica, colloidal silica, attapulgite, china clay, talc, kaolin and combinations thereof.

The pesticide formulation may further comprise a diluent, such as lactose, starch, urea, water soluble inorganic salts and combination thereof.

The pesticide formulation may further comprise one or more surfactants, such as polysorbate-type non-ionic surfactant, styrene acrylic dispersant polymers, acid resin copolymer-based dispersing agents, potassium polycarboxylate, sodium alkyl naphthalene sulphonate blend, sodium (diisopropyl)naphthalene sulphonate, sodium salt of naphthalene sulphonate condensate, lignin sulphonate salts and combinations thereof.

Licochalcone C, composition, or formulation comprising it, is applied in the method of any one of the above embodiments to the plant or part, organ or plant propagation material thereof by spraying, immersing, dressing, coating, pelleting or soaking.

### Definitions

The term “pesticide” as used herein refers to compounds effective for controlling, preventing, reducing or eradicating plant-pathogen infestation or instances thereof, on a plant, plant organ, plant part, plant propagation material or the soil surrounding said plant and includes antibacterial agents, fungicides, herbicides, and insecticides.

The term “active pesticidal ingredient” as herein refers to a compound that is effective as a pesticide.

The term “plant organ” as used herein refers to the leaf, stem, root, and reproductive structures.

The term “plant part” as used herein refers to a vegetative plant material such as a cutting or a tuber; a leaf, flower, bark or a stem.

The term “plant propagation material” as used herein refers to a seed, root, fruit, tuber, bulb, rhizome, or part of a plant.

The term “pesticidal effective amount” as used herein refers to an amount of the pesticide that is effective for controlling, preventing, reducing or eradicating plant-pathogen infestation or instances thereof, on a plant, plant organ, plant part, plant propagation material or the soil surrounding said plant.

The terms “class”, “order”, “family”, “genus”, and “species” are used herein according to Art 3.1 of the International Code of Nomenclature for algae, fungi, and plants.

The term “comprising”, used in the claims, is “open ended” and means the elements recited, or their equivalent in structure or function, plus any other element or elements which are not recited. It should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a composition comprising x and z” should not be limited to compositions consisting only of compounds x and z. Also, the scope of the expression “a method comprising the steps x and z” should not be limited to methods consisting only of these steps.

As used herein, the term “and/or” includes any and all combinations of one or more of the associated listed items. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

Unless otherwise indicated, all numbers used in this specification are to be understood as being modified in all instances by the term “about”. Unless specifically stated, as used herein, the term “about” is understood as within a range of normal tolerance in the art, for example within two standard deviations of the mean. In one embodiment, the term “about” means within 10% of the reported numerical value of the number with which it is being used, preferably within 5% of the reported numerical value. For example, the term “about” can be immediately understood as within 10%, 9%, 8%, 7%, 6%, 5%, 4%, 3%, 2%, 1%, 0.5%, 0.1%, 0.05%, or 0.01% of the stated value. In other embodiments, the term “about” can mean a higher tolerance of variation depending on for instance the experimental technique used. Said variations of a specified value are understood by the skilled person and are within the context of the present invention. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges, for example from 1-3, from 2-4, and from 3-5, as well as 1, 2, 3, 4, 5, or 6, individually. This same principle applies to ranges reciting only one numerical value as a minimum or a maximum. Unless otherwise clear from context, all numerical values provided herein are modified by the term “about”. Other similar terms, such as “substantially”, “generally”, “up to” and the like are to be construed as modifying a term or value such that it is not an absolute. Such terms will be defined by the circumstances and the terms that they modify as those terms are understood by those of skilled in the art. This includes, at very least, the degree of expected experimental error, technical error and instrumental error for a given experiment, technique or an instrument used to measure a value.

The invention will now be illustrated by the following non-limiting Examples.

### EXAMPLES

### List of Abbreviations

RPM—Revolutions per minute
RCF—Relative centrifugal force
CFU—Colony forming unit
PDBC—Potato dextrose broth with 20 ug/ml chloramphenicol
PDAC—Potato dextrose agar with 20 ug/ml chloramphenicol
PDAT—Potato dextrose agar with 12 ug/ml tetracycline
DMSO—Dimethyl sulfoxide
LB—LB broth
LBA—LB agar
SCH—Schmittner medium
2:PDBC—PDBC diluted 2 fold by sterile distilled water
PDA—Potato dextrose agar
PDBT—Potato dextrose broth with 12 ug/ml tetracycline

### Example 1. Microplate Based Assay of Licochalcone C Bioactivity Screening Against Rhizoctonia Solani

Summary:

Diluted in DMSO Licochalcone C was added to microplate wells and mixed with 50 μl of hyphae suspension and growth of the fungus, starting from blended hyphae, was monitored by plate reader and visual inspection.

The following Materials, methods and equipment were used:

Materials: PDAC, PDBC, DMSO

Equipment: Plate reader, Centrifuge, Shaker, Incubator

Method:

Inoculum Preparation of Rhizoctonia solani Hyphae:

Grow Rhizoctonia on PDAC in 90 mm petri plates to get growing hyphae within 1-4 days.

Add 50 ml of PDBC medium into a sterile 250 ml Erlenmeyer flask.

Cut the solid medium by scalpel to several small pieces and insert them into the Erlenmeyer flask.

Grow the culture for 2-4 days using shaker at 27° C. and 150 RPM.

Discard the liquid and pour the hyphae on an empty Petri dish.

Cut many small pieces from the hyphae using a scalpel and insert them into a sterile 250 ml Erlenmeyer flask with 50 ml of PDBC medium.

Prepare 4 bottles with culture and grow for 3 days at 27° C. shaking at 150 RPM.

Chill the culture in the fridge for 1 h.

Pour the cold culture into a 250 ml beaker.

Add 20 ml of cold PDBC, so that the mixture will cover the blender knife.

Blend the culture with a blender for 2 min on ice at maximum speed, move the blender up and down several times.

Keep the mixture on ice.

Transfer about 5 ml of the blended mixture into a 15 ml tube on ice.

Homogenize the culture in the 15 ml tube for 2 min on ice, move the tube up and down as needed.

Homogenize several batches of 5 ml as above to prepare the amount that is needed (5 ml of homogenized culture would make about 100 ml of inoculum).

Dilute a portion of the homogenate 10-fold to check the concentration of the homogenate.

The concentration of the suspension should be 4×10⁴ CFU/ml (diluted 10-fold concentration should be 4000 CFU/ml).

Dilute the inoculum stock 1:20 in PDBC—1 ml in 20 ml, or calculate the dilution needed, to prepare final concentration of 2000 CFU/ml. The amount in each well should be about 100 CFU.

Microplate Preparation for Licochalcone C Bioactivity Experiment:
1) Take a stock solution of purified 1% Licochalcone C in DMSO from the −20 freezer and thaw it on the bench.
2) Take 11 of stock solution of 1% Licochalcone C and dilute up to 250 ppm with 39 μl of water.
3) Take 10 μl of the diluted (250 ppm) Licochalcone C solution into the wells of the microplate using a multi-pipette.
4) Add 40 μl of vigorously mixed spore suspension inoculum to the wells of the microplate using a multi-pipette.
5) Seal the plate with transparent sealer
6) Shake the plate for 10 min at 2000 RPM to mix Licochalcone C with the hyphae suspension 7) Centrifugate the plate at 1000RCF for is and stop to collect the liquid at the bottom of the plate
8) Keep the microplate on the bench until it is read by the plate reader
9) Read the plate using the plate reader
10) Collect the plates on the bench
11) Insert collected plates to a plastic box with cloth cover and put the box in the incubator at 27° C.

Screening of Plates:
1) Screen plate at 3 more dates: 3d, 7d, 14d and 21d following the assay start
2) Calculate the difference of absorbance between each screen and the read at zero time
3) Calculate the percentage of growth inhibition of each well at each time point. Use the results of the DMSO treatment of the control plate as 100% growth.

Results: see Example 6.

### Example 2. Microplate Based Screening of Licochalcone C with Potential Bioactivity Against Pythium aphanidermatum

Summary:

Diluted in DMSO Licochalcone C was added to microplate wells and mixed with 50 μl of zoospores in PDBC suspension and the growth of the fungus, starting from zoospores, was monitored by plate reader and visual inspection.

The following Materials, methods and equipment were used:

Materials:
SCH, PDBC, DMSO

Equipment:

Plate reader, Centrifuge, Shaker, Incubator

Method:

Inoculum Preparation of Pythium Hyphae:

Grow Pythium aphanidermatum on SCH in 90 mm petri plates to get sporulating hyphae. Each plate will produce 50 ml of zoospores suspension which will be enough for bioactivity screening for ten 96-well plates.

Add 60 ml of sterile H₂O into a sterile 250 ml Erlenmeyer flask.

Cut the solid medium of 2 plates by scalpel to 12 pieces (each plate) and insert them into the Erlenmeyer flask (the solid pieces should be covered by the water).

Let the hyphae sporulate overnight at 17° C.

Shake the Erlenmeyer flask by hand to suspend the zoospores.

Filter the suspension into 50 ml tube through 16-layer gauze.

Transfer the suspension into a sterile 500 ml bottle.

Discard the solids and disinfect the Erlenmeyer flask with hypochlorite.

Chill the zoospore suspension on ice.

Evaluate the zoospores concentration in the suspension (the concentration should be 1000-4000 spores/ml).

Dilute the suspension by sterile fridge cold distilled H₂O in a sterile 500 ml bottle.

Add the same volume (as the suspension) sterile fridge cold 2:PDBC to get 500-2000 spores/ml inoculum. This dilution will result in the amount of 25-100 zoospores in each well.

Keep the zoospore suspension inoculum on ice.

Microplate Preparation for Licochalcone C Bioactivity Experiment:
1) Take a stock solution of purified 1% Licochalcone C in DMSO from the −20 freezer and thaw it on the bench.
2) Take 1 μl of stock solution of 1% Licochalcone C and dilute up to 250 ppm with 39 μl of water.
3) Take 10 μl of the diluted (250 ppm) Licochalcone C solution into the wells of the microplate using a multi-pipette.
4) Add 40 μl of vigorously mixed spore suspension inoculum to the wells of the microplate using a multi-pipette.
5) Seal the plate with transparent sealer
6) Shake the plate for 10 min at 2000 RPM to mix the Licochalcone C with the hyphae suspension
7) Centrifugate the plate at 1000RCF for is and stop to collect the liquid at the bottom of the plate
8) Keep the microplate on the bench until it is read by the plate reader
9) Read the plate using the plate reader
10) Collect the plates on the bench
11) Insert collected plates to a plastic box with cloth cover and put the box in the incubator at 27° C.

Screening of Plates:
1) Read out the plate at 3 more dates: 3d, 7d, 14d and 21d following the assay start
2) Calculate the difference of absorbance between each readout and the readout at zero time
3) Calculate the percentage of growth inhibition of each well at each time point. Use the results of the DMSO treatment of the control plate as 100% growth Results: see Example 6.

### Example 3. Microplate Based Screening of Licochalcone C with Potential Bioactivity Against Fusarium oxysporum

Summary:

Diluted in DMSO Licochalcone C was added to microplate wells and mixed with freshly prepared spore suspension and growth of the fungus, starting from frozen spores, was monitored using the plate reader and by visual inspection.

Background:

Fusarium is a fungus of belonging to the Ascomycetes, and it is a soil borne pathogen. It is quite easy to produce large amounts of spores of Fusarium and they survive in liquid 60% glycerol at −20° C. Thus, we used frozen spores' stock in the bioactivity screening experiments rather than prepare fresh spores for each experiment.

Aim:

To determine the effect of Licochalcone C on the survival and growth of Fusarium.

The following materials, methods and equipment were used:

Materials: PDAC, PDBC, DMSO

Equipment: Plate reader, Centrifuge, Shaker, Incubator

Method:

Fusarium Spore Suspension Preparation:
1) Put agar block of growing fusarium on PDAC in the middle of a PDAC plate and grow for 9 days at 25° C.
2) Chill the plate in the fridge for at least 1 h
3) Add 30 ml of fridge cold, sterile, 60% glycerol solution to the 50 ml tube
4) Cut the agar with the hyphae and spores, from one plate, to small pieces, by scalpel, and insert them into the 50 ml tube with 30 ml 60% glycerol
5) Shake for 1 min at 3000 RPM
6) Keep spores on ice during the whole process
7) Transfer the liquid to a new 50 ml sterile tube—about 25 ml should be recovered
8) Filter the spore suspension through 16 layer of gauze cloth directly into a clean sterile 50 ml tube to discard the hyphae
9) Calculate the spore concentration (at 40×10 magnification) and dilute by cold sterile 60% glycerol solution to get 2×10⁵ spores/ml
10) Aliquot 1 ml of spore suspension into 1.5 ml tubes—each aliquot should yield 20 plates for screening
11) Store the spore suspension at −20° C.

Spore Suspension Preparation for Screening:
1) Take 1 ml frozen spore suspension from the freezer and thaw it on ice
2) Mix 200 μl spore suspension with 20 ml fridge cold PDBC in a 50 ml tube to make 2000 spores/ml suspension
3) Use this amount to screening of 4 microplates with 100 spores per well

Microplate Preparation for Licochalcone C Bioactivity Experiment:
1) Take a stock solution of purified 1% Licochalcone C in DMSO from the −20 freezer and thaw it on the bench.
2) Take 1 μl of stock solution of 1% Licochalcone C and dilute up to 250 ppm with 39 μl of water.
3) Take 10 μl of the diluted (250 ppm) Licochalcone C solution into the wells of the microplate using a multi-pipette.
4) Add 40 μl of vigorously mixed spore suspension inoculum to the wells of the microplate using a multi-pipette.
5) Seal the plate with transparent sealer
6) Shake the plate for 10 min at 2000 RPM to mix the materials with the hyphae suspension
7) Centrifugate the plate at 1000RCF for is and stop to collect the liquid at the bottom of the plate
8) Keep the microplate on the bench until it is read by the plate reader
9) Read the plate using the plate reader
10) Collect the plates on the bench
11) Insert collected plates to a plastic box with cloth cover and put the box in the incubator at 25° C.

Readout of the Plates:
1) Collect the readout of the plate at 3 more dates: 3d, 7d, 14d and 21d following the assay start
2) Calculate the difference of absorbance between each readout and the readout at zero time
3) Calculate the percentage of growth inhibition of each well at each time course. Use the results of the DMSO treatment, of the control plate as 100% growth.

Results: see Example 6.

### Example 4. Microplate Based Screening of Licochalcone C with Potential Bioactivity Against Sclerotinia sclerotiorum

Summary:

Diluted in DMSO purified Licochalcone C was added to microplate wells and mixed with 50 μl of hyphae suspension and growth of the fungus starting from blended hyphae was monitored by visual inspection.

### BACKGROUND

Sclerotinia sclerotiorum is a fungus of belonging to the Ascomycetes and it is a soil borne pathogen. It is difficult to produce large amounts of spores of Sclerotinia sclerotiorum, that led to decision to use hyphae in this screening rather than spores for inoculation.

The following materials, methods and equipment were used:

Materials: PDBC, PDA, PDAT, PDBT, DMSO

Equipment: Centrifuge, Shaker, Incubator

Method:

Inoculum Preparation of Sclerotinia sclerotiorum Hyphae:

Grow Sclerotinia sclerotiorum on PDA in tube at 21° C. for 4 days.

Transfer agar block and grow Sclerotinia sclerotiorum on PDAT in 90 mm Petri dishes at 21° C. to get growing hyphae within 3 days.

Add 50 ml of PDBT medium into a sterile 250 ml square flask.

Cut the solid medium by scalpel to 15 very small pieces (1×5 mm) and insert them into the square flask.

Grow the culture for 2 days using shaker at 21° C. and 130 RPM.

Discard the liquid and pour the hyphae on an empty Petri dish.

Cut many small pieces from the hyphae (avoid using the agar pieces) using a scalpel and insert them into a sterile 250 ml square flask containing 50 ml of PDBT medium.

Grow for 2 days at 21° C., shaking at 130 RPM to get fast growing dispersed hyphae.

Chill the culture in the fridge for 1 hour.

Pour the cold culture into a 50 ml tube.

Keep the mixture on ice.

Transfer about 5 ml of the blended mixture into a 15 ml tube on ice.

Homogenize the culture in the 15 ml tube for 2 min on ice.

Homogenize several batches of 5 ml as above to prepare the amount that is needed (5 ml of homogenized culture would make about 50 ml of inoculum).

Dilute a portion of the homogenate 10-fold to check the concentration of the homogenate. the concentration of the suspension should be 2×10⁴ CFU/ml (diluted 10-fold concentration should be 2000 CFU/ml).

Dilute the inoculum stock 1:10 in PDBC—2 ml in 20 ml, or calculate the dilution needed, to prepare final concentration of 2000 CFU/ml. The final number of hyphae should be 100 CFU in each well.

Microplate Preparation for Activity Experiment:
1) Take a stock solution of purified 1% Licochalcone C in DMSO from the −20 freezer and thaw it on the bench.
2) Take 1 μl of stock solution of 1% Licochalcone C and dilute up to 250 ppm with 39 μl of water.
3) Take 10 μl of the diluted (250 ppm) Licochalcone C solution into the wells of the microplate using a multi-pipette.
4) Add 40 μl of vigorously mixed spore suspension inoculum to the wells of the microplate using a multi-pipette.
5) Seal the plate with transparent sealer
6) Shake the plate for 10 min at 2000 RPM to mix the Licochalcone C with the hyphae suspension
7) Centrifugate the plate at 1000RCF for is and stop to collect the liquid at the bottom of the plate.
8) Collect the plates on the bench until all microplates are ready for incubation.
9) Insert microplates into a plastic box and put the box in the incubator at 21° C.

Screening of Plates:
1) Screen plate at 5 dates: 4, 7, 14 and 21 days after inoculation
2) Use a lamp for visual assessment of Licochalcone C effect on fungal growth over time
3) Screen plates after removing their cover, if there is liquid on the cover (from inside) evaporate the liquid by a heated block at 60° C.
4) Compare the hyphal growth of each well to the hyphal growth of the control plate wells (wells containing active fungicides or 0.5% DMSO solution)
5) Write the results on a special form: clear well=3 (no growth of hyphae), normal hyphal structure=1 (normal growth), inconclusive=2 (solid structure of unexpected type, or partial cover of the area)

Results: see Example 6.

### Example 5. Microplate Based Screening of Licochalcone C for Potential Bioactivity Against Pseudomonas syringae

Background:

Pseudomonas is a rod-shaped Gram-negative bacterium. Frozen bacterial stock in 60% glycerol was used as an inoculum for the bioactivity screening experiments.

Summary:

Diluted in DMSO Licochalcone C was added to microplate wells and mixed with 100 μl of frozen bacteria suspension and growth of the Pseudomonas was monitored by visual inspection.

The following materials, methods and equipment were used:

Materials: LB, LBA, DMSO

Equipment: Centrifuge, Shaker, Incubator

Method:

Pseudomonas Suspension Preparation:
1) Grow Pseudomonas on LBA plates at 28° C. for 2 days to get a single colony
2) Transfer a single colony using a sterile toothpick into a 50 ml sterile tube containing 5 ml LB and grow for 24 at 28° C. and 150 RPM
3) Chill the tube in the fridge for 1 h
4) Add 7.5 ml of fridge cold, sterile, glycerol solution to the tube—to get 60% glycerol solution
5) Mix well but gently to get perfect mixing—use vortex at 1000 RPM
6) Aliquot 100 μl of bacteria suspension in 60% glycerol into 1.5 ml tubes—each aliquot should be enough for screening of 10 microplates
7) Store the bacteria suspension in 60% glycerol at −20° C.

Pseudomonas Suspension Preparation for Bioactivity Screening Experiment:
1) Take 1.5 ml tube with 100 μl frozen Pseudomonas suspension from the freezer and thaw it on ice
2) Prepare in the hood 50 ml tubes with 40 ml fridge cold LB
3) Mix 40 μl of bacteria suspension with 40 ml fridge cold LB in a 50 ml tube. This amount is enough for activity screening of 10 microplates
4) Use this suspension for bioactivity screening experiments

Microplates' Preparation for Bioactivity Screening Experiment:
1) Take a stock solution of purified 1% Licochalcone C in DMSO from the −20° C. freezer and thaw it on the bench.
2) Take 1 μl of stock solution of 1% Licochalcone C and dilute up to 250 ppm with 39 μl of water.
3) Take 10 μl of the diluted (250 ppm) Licochalcone C solution into the wells of the microplate using a multi-pipette.
4) Add 40 μl of vigorously mixed bacterial suspension inoculum to the wells of the microplate using a multi-pipette.
5) Seal the plate with transparent sealer
6) Shake the plate for 10 min at 2000 RPM to mix the Licochalcone C with the bacteria suspension
7) Centrifugate the plate at 1000RCF for is and stop to collect the liquid at the bottom of the plate
8) Insert the plates to a plastic box with cover and put the box in the incubator at 28° C.

Bioactivity Screening of Microplates:
1) Screen the microplate at 5 dates: 3, 5, 7, 14 and 21 days after inoculation 2) Use a lamp to visually evaluate the bacterial growth
3) Prepare plates for screening: shake plate at 2000 RPM for 2 min to suspend the bacteria and then centrifuge plate at 1000RCF for a few seconds
4) Screen the microplates after removing their cover, if there is liquid on the cover (from inside) evaporate the liquid using a heated block at 60° C.
5) Compare the transparency of each well to the transparency of the control wells (wells containing control bactericide or 0.5% DMSO solution)

Record the results using the following interpretation: clear=3 (no growth of bacteria), turbid=1(normal bacterial growth), inconclusive=2 (very low turbidity compared to growth in 0.5% DMSO solution)

Results: see Example 6.

Statistical Analysis for In-Vivo Validation Experiments.

To evaluate the effect of a Licochalcone C in infected plants compared to control plants (infected but not treated) the data was analysed by Student's t-test and the p-value is calculated. The minimum number of repeats in each experiment was 3. Results were considered significant if p<0.05. The data presented as mean with standard error mean from biological replicates. * means that p-value <0.05, ** means that p-value is <0.01, # means that p-value <0.1.

### Example 6. Results of In Vitro Experiments Based on Protocols of Examples 1-5

In-Vitro Screening Matrix

Licochalcone C was screened against selected agricultural pests (as indicated in the tables below). Bioactivity values are in % and reflect the potential of eradicating the target pests.

Rules for Bioactivity Relative Value Calculation (Expressed in % from Maximal Value)
a. Rhizoctonia solani, Sclerotinia sclerotiorum, Fusarium oxysporum, Pythium aphanidermatum—activity grade (1/2/3) X repeats #X days of activity/252 (maximal value 3×4×21=252)*100
b. Pseudomonas syringae—activity grade (1/2/3) X repeats #X days of activity/168 (maximal value 3×4×14=168)*100

TABLE 1
Bioactivity values of Licochalcone C on various target pests

| Pathogen | Relative Activity value (%) |
|---|---|
| Rhizoctonia solani | 100 |
| Pythium aphanidermatum | 100 |
| Fusarium oxysporum | 25 |
| Sclerotinia sclerotiorum | 13 |
| Pseudomonas syringae | 50 |

In summary, Licochalcone C is effective pesticide against the following pests: Pythium aphanidermatum (positive results are provided below in in-vivo results section), Rhizoctonia solani (positive results are provided below in in-vivo results section), Sclerotinia sclerotiorum, Fusarium oxysporum and Pseudomonas syringae.

### Example 7. Formulation Preparation for In-Vivo (Under Greenhouse Conditions) Validation

Formulation 1—the formulation with final concentration of 400 ppm is composed of:
A. 40% of 0.1% of Licochalcone C in aqueous solution of 25% of Na₂CO₃
B. 10% (w/w) of Silwet stock solution 0.6%
C. 10% (w/w) of Xanthan Gum stock solution 0.4%
D. 40% of water.

To prepare solution A Licochalcone C was dissolved in water to get 0.1% solution and sonicated for 5-10 mins. Afterwards, Na₂CO₃ was added to the final concentration of 25% and mixed well (pH of this solution should be 8).

A, B, C and D were mixed well to get the final formulation. The final formulation 1 was either applied as 400 ppm or diluted to the required concentrations and applied to cucumber seedlings.

Formulation 2—the formulation with final concentration of 400 ppm is composed of:
A. 0.4% of 10% Licochalcone C in ethanol with Tween 20
B. 10% (w/w) of Silwet stock solution 0.6%
C. 10% (w/w) of Xanthan Gum stock solution 0.4%
D. 79.6% of water.

To prepare solution A Licochalcone C was dissolved in ethanol to get 1% solution and sonicated for 5-10 mins. Afterwards the non-ionic detergent Tween 20 was added to the final concentration of 1% and mixed well. The solution was evaporated under nitrogen to get 10% Licochalcone C solution.

A, B, C and D were mixed well to get the final formulation. The final formulation 4 was either applied as 400 ppm or diluted to the required concentrations and applied to cucumber seedlings.

### Example 8. In-Vivo Validation Under Greenhouse Conditions in Cucumber Seedlings Infected with Pythium aphanidermatum

General description: Pythium aphanidermatum disease severity development was evaluated following preventative treatment by Licochalcone C (LIC)

Pythium inoculum Preparation:
1) Insert 10 ml Quinoa seeds into a 100 ml bottle.
2) Add 10 ml sterile distilled water.
3) Let the seeds absorb the water for 24 h in the fridge.
4) After 24 h put a breathing cloth on top of the bottle, and close loosely the lid on top.
5) Autoclave for 40 min (at 121° C.) [liquid cycle]
6) Let cool in the hood and remove the lid.
7) Inoculate the quinoa seeds with a small block of Pythium grown on PDAC plate.
8) Put back the breathing cloth and lid.
9) Put the solid phase Pythium growth bottle in the incubator, at 27° C.
11) After 5 days the Pythium should be ready to inoculate plants.
12) Homogenize the Pythium hyphae in the desired volume:
   A. Use a 250 ml beaker and a stick blender to prepare the blend.
   B. Add 100 ml water
   C. Add 1 g of Pythium solid phase culture, to get 1% hyphae suspension.
   D. Homogenize at high speed for 2 min on ice.
   E. Dilute the homogenized hyphae suspension with sterile water to get 0.5% hyphae suspension.
   F. Use the diluted homogenized hyphae suspension immediately to inoculate the soil/keep in 4° c. for later usage.

Seedlings' Germination Conditions.
1) Use 6 days old cucumber seedlings germinated a seedling tray. Use appropriate cucumber cultivars, to allow disease development. Seedlings should be 6 days old. Soil-planting substrate composition is based on quality coconut and perlite (50-50%), with characteristics of high hydraulic conductivity, highly ventilated and completely inert
2) Seedlings are germinated in the greenhouse under in nursery conditions, with 40 ppm N:P:K fertiliser, watered twice a day.
3) Before experiment conducted, the tray with seedlings, with fully opened cotyledons, without first true leaf, is taken out from watering system, to allow soaking of treatment
4) On the 6th day from seeding, the treatment was applied. At day 7th the inoculum are added into each seedling cell.

Treatment Application
1) Licochalcone C was formulated according to Example 7
2) In case of drenching application, 5-6 ml of formulated Licochalcone C was applied specifically to each seedling cell
3) In case of spraying application, a border was applied between different treatment conditions. 5 ml of molecule formulation in the appropriate concentration was applied for each 8 seedlings. Sprayed by plastic sprayer, until full drainage of seedlings' leaves.
4) In small scale experiments, the number of tested seedlings was n=8 for each (exps. 187a, 206, 177a, 187b, 206b) condition. In large scale experiments (204, 271 and 286) the number of tested seedlings was n=24 for each condition, besides for non-treated, which number of tested seedlings, n=16.

Inoculation of Soil:
1) The seedlings were inoculated 24 h following treatment with Licochalcone C (preventative approach).
2) Use a pipette to spread 5-6 ml of the inoculate on the soil surface, specifically to each seedling cell. The soil in each seedlings' cell should absorb all the volume of the inoculum. The treatment and the inoculum are expected to evenly distribute in the rhizosphere.

Growth and Analysis:
1) Grow the cucumber plants for 7 more days under normal watering regime
2) At the 7th day (14 days from seeding) the disease severity evaluation was performed
3) Disease symptoms: seedlings should start falling because of root rot, and brown color should be seen on the shoot just above ground.
4) Count the sick and dead seedlings at day 7 from inoculation
5) Calculate the death percentage per of each treatment.

Results: Licochalcone C showed excellent results in preventing Pythium disease in cucumber seedling with efficacy up to 100% with 2 different types of formulations in dosages between 100 to 400 ppm.

### Example 9. In-Vivo Validation Under Greenhouse Conditions in Cucumber Seedlings Infected with Rhizoctonia solani

General description: Rhizoctonia disease severity were evaluated following preventative treatment with Licochalcone C. Hyphae were used to infect 6 days old cucumber seedlings with concomitant treatment with Licochalcone C

Rhizoctonia inoculum Preparation:
1) Insert 10 ml Quinoa seeds into a 100 ml bottle.
2) Add 10 ml sterile distilled water.
3) Let the Quinoa seeds absorb the water for 24 h in the 4 C fridge.
4) After 24 h put a breathing cloth on top of the bottle, and close loosely the lid on top.
5) Autoclave for 40 min (at 121° C.) [liquid cycle]
6) Let cool in the hood and remove the lid
7) Inoculate the quinoa seeds with a small block of Rhizoctonia grown on PDAC (Potato dextrose agar with 20 ug/ml chloramphenicol) plate.
8) Put back the breathing cloth and lid.
9) Put the solid phase Rhizoctonia growth bottle in the incubator, at 27° C.
10) After 8-10 days the Rhizoctonia should be ready for cucumber seedlings inoculation.
11) Homogenize the Rhizoctonia hyphae in the desired volume:
   Use a 250 ml beaker and a stick blender to prepare the blend.
   Add 100 ml water
   Add 1 g of rhizoctonia solid phase culture to get 1% hyphae suspension.
   Homogenize at high speed for 2 min on ice.
12) Dilute the homogenized hyphae suspension with sterile water to get 0.5% hyphae suspension.
13) Use the diluted homogenized hyphae suspension immediately to inoculate the soil (keep in 4° C. for later usage).

Cucumber Seedlings Germination Protocol
1) Use 6 days old cucumber germinated 136 seedlings tray. Use appropriate sensitive cucumber cultivars, to allow disease development. Seedlings should be 6 days old. Soil-planting substrate composition is based on quality coconut and perlite (50-50%), with characteristics of high hydraulic conductivity, highly ventilated and completely inert
2) Seedlings are germinated in the greenhouse, in nursery conditions, with 40 ppm N:P:K fertiliser, watered twice a day (summer). Under winter conditions different watering regime will be required
3) Before experiment conducted, the tray with seedlings, with full sized cotyledons, without first true leaf, is taken out from watering system, to allow treatment incorporation into soil.
4) On the 6th day from seeding, the treatment will be applied. At day 7th the inoculum is added into each seedling cell.

Treatment Application
1) Licochalcone C was formulated according to Example 7
2) In case of drenching application 5-6 ml of treatment, in the respective concentration was applied specifically to each seedling cell
3) In case of spraying application, a border will be applied between different treatment conditions. 5 ml of formulated Licochalcone C in the appropriate concentration was applied to cucumber seedlings. The spraying was done by plastic hand sprayer, until full drainage of seedlings' leaves.
4) In small scale experiments, the number of tested seedlings was n=8 per (exps. 178 and 185) treatment. In large scale experiments (exp. 252) the number of tested seedlings was n=24 per treatment, besides for non-treated, where n=16.

Inoculation of Soil:
1) Inoculation was applied 24 h following treatment with Licochalcone C (preventative approach). Following treatment, and until inoculation, seedlings were kept un-watered, to avoid washing out of Licochalcone C.
2) Use a 10 ml pipette to spread 5-6 ml of the inoculum on the soil surface, specifically to each seedling cell. The soil in each seedlings' cell should absorb all the volume of the inoculum. The treatment and the inoculum are expected to evenly distribute in the rhizosphere.
3) Growth and analysis:
4) Grow the cucumber plants for 7 more days under normal watering regime
5) At the 7th day (14 days from seeding) perform final disease evaluation
6) Phenotype of disease development: seedlings should start falling due to root rot, and brown colour should be seen on the shoot just above the ground.
7) Count the sick and dead seedlings
8) Calculate the plants death percentage per each treatment.

Results: Licochalcone C showed excellent results in preventing Rhizoctonia disease in cucumber seedlings with efficacy between 66.66 to 100% with 2 different types of formulations in dosages between 100 to 400 ppm.

### REFERENCES

Erlacher A., Cardinale M., Grosch R., Grube M., Berg G. The impact of the pathogen Rhizoctonia solani and its beneficial counterpart Bacillus amyloliquefaciens on the indigenous lettuce microbiome. Front Microbiol. 2014; 5: 175. Published online 2014 Apr. 21. doi: 10.3389/fmicb.2014.00175.
Hofte M. and De Vos P. Plant pathogenic pseudomonas species. Gnanamanickam S. S. (ed.), Plant-Associated Bacteria, 2006; 507-533.
Jenkins J. E. E., Clark Y. S. and Buckle A. E. Fusarium diseases of cereals. Research Review 4. October 1988.
Frank N. Martin & Joyce E. Loper. Soilborne Plant Diseases Caused by Pythium spp.: Ecology, Epidemiology, and Prospects for Biological Control. Critical Reviews in Plant Sciences, 1999; 18:111-181.
Moore. L. W. Pseudomonas syringae: disease and ice nucleation activity. Ornamentals Northwest Newsletter. (1988) 12:4-16.

1. A method for controlling, preventing, reducing or eradicating the instances of plant-pathogen infestation on a plant, plant organ, plant part, or plant propagation material, the method comprising: applying to a plant, plant part, plant organ or plant propagation material, or to soil surrounding said plant, any one of the following:
(a) a pesticidally effective amount of a compound (E)-3-[4-hydroxy-2-methoxy-3-(3-methylbut-2-enyl)phenyl]-1-(4-hydroxyphenyl)prop-2-en-1-one, or
(b) an agriculturally acceptable salt of said compound, or
(c) a pesticide composition comprising said compound as an active pesticidal ingredient,
wherein said plant-pathogen is a member selected from: an order of the class Agaricomycetes; a genus of the family Pythiaceae; a genus of the family Sclerotiniaceae selected from Sclerotinia and Fusarium; and a family of the order Pseudomonadales.

2. The method of claim 1, wherein said plant-pathogen is a member of the class Agaricomycetes.

3. The method of claim 2, wherein said Agaricomycetes plant-pathogen is a member of the order Cantharellales.

4. The method of claim 3, wherein said Cantharellales plant-pathogen is a genus of the family Ceratobasidiaceae.

5. The method of claim 4, wherein said Ceratobasidiaceae plant-pathogen is a member of the genus Rhizoctonia, such as Rhizoctonia solani.

6. The method of claim 1, wherein said plant-pathogen is a member of the family Pythiaceae.

7. The method of claim 6, wherein said Pythiaceae plant-pathogen is a member of the genus Pythium, such as Pythium aphanidermatum.

8. The method of claim 1, wherein said plant-pathogen is a genus of the family Sclerotiniaceae selected from Sclerotinia and Fusarium, such as Sclerotinia sclerotiorum and Fusarium oxysporum.

9. The method of claim 1, wherein said plant-pathogen is a member of the order Pseudomonadales.

10. The method of claim 9, wherein said Pseudomonadales plant-pathogen is a genus of the family Pseudomonadaceae.

11. A pesticide composition comprising a compound (E)-3-[4-hydroxy-2-methoxy-3-(3-methylbut-2-enyl)phenyl]-1-(4-hydroxyphenyl)prop-2-en-1-one or an agriculturally acceptable salt thereof as an active pesticidal ingredient.
